(19) United States
(12) Patent Application Publication
(10) Pub. No.: US 2017/0113084 A1
(43) Pub. Date: Apr. 27, 2017

(54) Rapid Deployment Boom-Mounted Sprinkler Gun with Distance and Heat Sensing Capabilities

(71) Applicant: Garry Thomsen, Mesa, AZ (US)

(72) Inventor: Garry Thomsen, Mesa, AZ (US)

(21) Appl. No.: 15/285,291

(22) Filed: Oct. 4, 2016

Related U.S. Application Data
(63) Continuation-in-part of application No. 15/219,069, filed on Jul. 25, 2016.
Application No. 15/219,069 is a continuation-in-part of application No. 62/245,364, filed on Oct. 23, 2015.

(30) Foreign Application Priority Data
Aug. 16, 2016 (AU) 2016216571
Sep. 7, 2016 (CA) 2941167

(51) Int. Cl. A62C 37/09; A62C 33/04; A62C 37/11

(52) U.S. Cl. CPC A62C 37/09; A62C 37/11; A62C 33/04

(57) ABSTRACT

A rapid deployment boom-mounted sprinkler gun is an apparatus that allows for unmanned dispersal of fire extinguishing substance from a boom of a mobile crane. The apparatus includes a mounting housing, a fastening mechanism, an at least one imaging device, a sprinkler gun, a water-receiving tube, a wireless communication device, and a power source. The mounting housing is mounted to the boom and the sprinkler gun is rotatably mounted onto a top surface of the mounting housing. The water-receiving tube is in fluid communication with the sprinkler gun and an external water supply to discharge fire extinguishing substance. The imaging device is externally mounted to a front surface of the mounting housing in order to provide a live feed. The wireless communication device is electronically connected to the imaging device in order to broadcast the live feed to an external control unit.

### FIELD OF THE INVENTION

The present invention relates generally to firefighting equipment and systems. More specifically, the present invention is an autonomous and boom-mounted water cannon apparatus that is used for extinguishing fires, in particular fires in heavy urban regions. The present invention provides a safe, effective, and unmanned means for addressing and putting out fires in difficult to reach areas. Additionally, the present invention includes a multitude of environment-sensing devices such as a camera and an infrared camera which provide the user with a live feed of the region in question.

### BACKGROUND OF THE INVENTION

Firefighting is a hazardous occupation as it involves exposing oneself to hazardous and deadly effects of fires time and time again. More specifically, this is due to the fact that firefighting personnel are directly exposed to extreme heat, excessive amounts of smoke and ash, unpredictable fire behavior due to variables such as wind and terrain, and structure failure. This can result in firefighting personnel being put in danger due to the unpredictability of fire and wildfire behavior. For example, the unpredictable conditions presented by the intense heat and smoke of fires may result in firefighting personnel becoming disoriented and as a result becoming trapped. In a worst case scenario, firefighting personnel may become trapped in a hazardous area with no possibility of rescue. In order to limit the exposure of firefighting personnel to the hazardous effects of fires, various firefighting equipment and methods have been developed. One popular method involves physically raising a water hose directly above or next to the fire through the use of an extendable boom from a firetruck or crane. Unfortunately, this method requires a trained firefighter to hold, aim, manage the water hose on the end of the extendable boom, thus still exposing the firefighter to the hazards of the fire.

The present invention is an autonomous and boom-mounted water cannon apparatus that is used for extinguishing fires, in particular fires in heavy urban regions. The present invention is designed to be mounted to an end of an extendable boom in order to deliver high volume of water or foam to a fire through an unmanned water cannon. The present invention additionally includes a multitude of environment-sensing devices which provide a user with a live feed from the perspective of the water cannon. Type of environment-sensing devices include a camera and an infrared camera. The information provided by the environment-sensing devices allow the user to identify potential hot spots and remotely control the water cannon. Because the present invention requires a bare minimum of personnel input for operation, firefighting resources may be allocated to higher priority tasks. Additionally, the present invention minimizes the need for firefighting personnel to risk their lives in a hazardous area while combating a fire. Finally, the present invention facilitates reaching and combating a fire located in a remote location that is normally unreachable or difficult to reach for firefighting personnel such as regions behind rural houses called the interface; the interface is the region between a backyard of a house and the adjoining forest.

### BRIEF DESCRIPTION OF THE DRAWINGS

FIG. 1 is a perspective view of the present invention.

FIG. 2 is a side view of the present invention.

FIG. 3 is a side view of an alternative embodiment of the present invention.

FIG. 4 is an electric schematic of the present invention.

FIG. 5 is an electronic schematic of the present invention.

### DETAIL DESCRIPTIONS OF THE INVENTION

All illustrations of the drawings are for the purpose of describing selected versions of the present invention and are not intended to limit the scope of the present invention.

The present invention is generally related to firefighting equipment and systems. More specifically, the present invention is an unmanned, remote controlled firefighting system which provides the maneuvering benefits of traditional aerial platform fire-fighting system without exposing personnel to the hazardous effects of a fire. The present invention is designed to be compatible with a mobile crane, in particular with a boom 20 of the mobile crane. In general, the present invention is mounted onto an end of the boom 20 in order to effectively spay a fire extinguishing substance directly onto a fire from a close and elevated position without the need for firefighting personnel to be directly involved, i.e. standing at the top of the boom 20 holding a water hose. Additionally, the present invention includes a multitude of environment-sensing devices which provide the user with valuable information in relation to the characteristics of the fire and the surrounding environment.

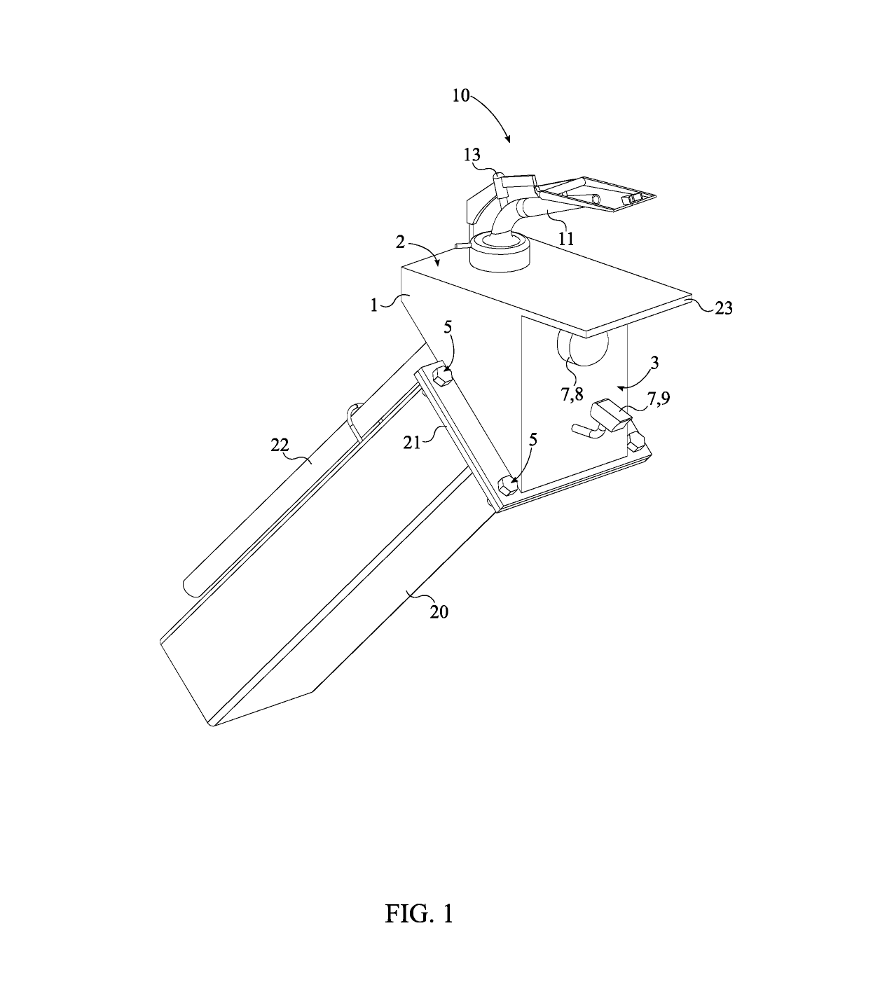

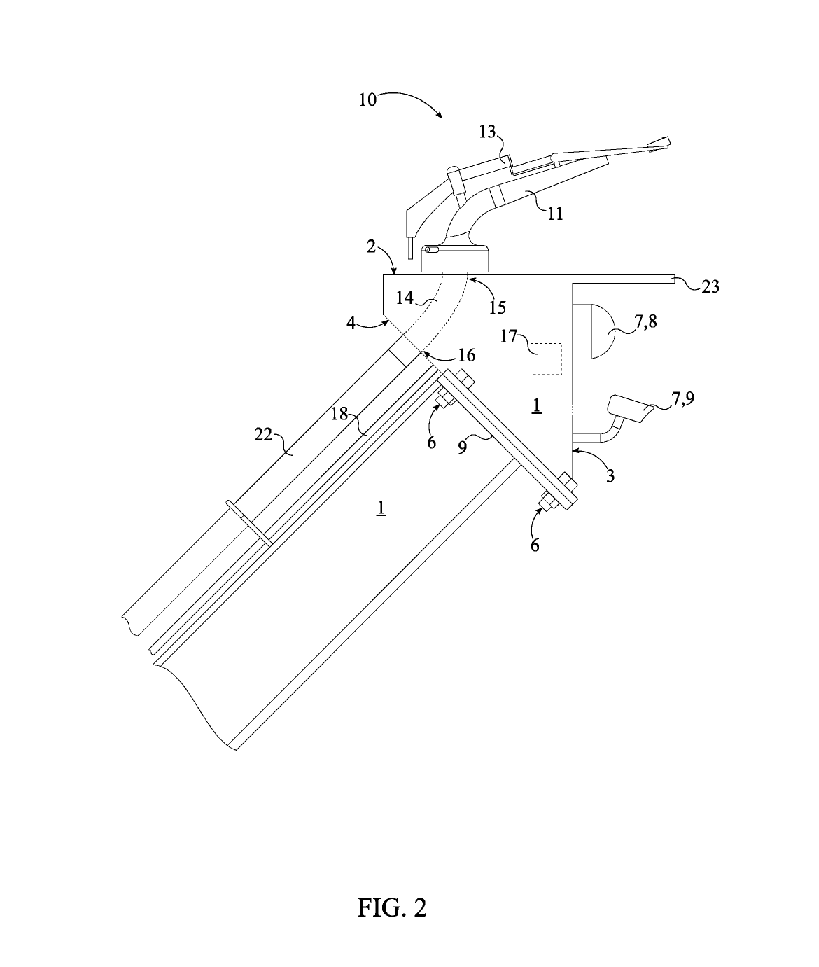

Referring to FIG. 1 and FIG. 2, the present invention comprises a mounting housing 1, a fastening mechanism 5, an at least one imaging device 7, a sprinkler gun 10, a water-receiving tube 14, a wireless communication device 17, an external control unit 26, and a power source 18. The mounting housing 1 houses and supports the constituents of the present invention. The preferred material composition for the mounting housing 1 is a rust-resistance metal in order to withstand the stresses and the environmental forces associated with firefighting. The mounting housing 1 is directly attached to a distal end-plate 21 of the boom 20 by the fastening mechanism 5, as seen in FIG. 2. In particular, the fastening mechanism 5 is mechanically integrated into a bottom surface 4 of the mounting housing 1. A multitude of devices and technologies may be used as the fastening mechanism 5 including, but not limited to, rivets, clamps, and other similar mechanisms. The sprinkler gun 10 receives, aims, focuses, and disperses a fire extinguishing substance onto a desired region. The sprinkler gun 10 is rotatably mounted onto a top surface 2 of the mounting housing 1. This allows the sprinkler gun 10 to rotate relative to the mounting housing 1 and therefore the boom 20 in order to disperse fire extinguishing substance onto a large area directly surrounding the present invention. In addition, in some embodiments of the present invention, the sprinkler gun 10 may rotate, tilt, and/or extend to further increase the possible coverage area. Furthermore, the sprinkler gun 10 may be implemented in a multitude of sizes in order to allow for higher flow rates if necessary. The water-receiving tube 14 connects the sprinkler gun 10 to a water reserve, more specifically a water supply line 22 of the mobile crane. A first end 15 of the water-receiving tube 14 is connected to the sprinkler gun 10 such that the first end 15 is in fluid communication with the sprinkler gun 10. A second end 16 of the water-receiving tube 14 is mechanically integrated into a bottom surface 4 of the mounting housing 1 in order to receive the water supply line 22 of the mobile crane. The second end 16 of the water-receiving tube 14 may be equipped with a fire hose adaptor in order to comply with industry standards and to ensure there are no leaks when the present invention is operational. The water-receiving tube 14 is preferably two and a half inches in diameter, similar to traditional fire hoses, although alternative sizing may also be utilized. In relation to the mobile crane, the water supply line 22 of the mobile crane is connected to the second end 16 of the water-receiving tube 14 so that the water supply line 22 can be in fluid communication with the water-receiving tube 14.

The imaging device 7, the wireless communication device 17, the external control unit 26, and the power source 18 work together to provide the user a live feed of the surrounding environment directly from the top of the boom 20. The imaging device 7 is externally mounted to a front surface 3 of the mounting housing 1 and continuously captures images of the surrounding environment. The wireless communication device 17 is internally mounted within the mounting housing 1 and is electronically connected to the imaging device 7. The wireless communication device 17 receives and wirelessly transfers the captured images from the imaging device 7 to the external control unit 26, the user. In particular, the wireless communication device 17 is communicably coupled to the external control unit 26. Type of technologies that may be used for the wireless communication device 17 include, but are not limited to, Bluetooth technologies, wireless networks such as Wi-Fi technologies, and other comparable/standard technologies. The external control unit 26 is any computing device that includes a screen and wireless data transfer capabilities. Type of devices that may be used as the external control unit 26 include, but are not limited to, laptops, personal computers, tablets, smartphones, and other similar technologies. Through the external control unit 26, the user may view images, videos, and other information derived from the electric components mounted within or on the mounting housing 1. Additionally, in some embodiments of the present invention, the external control unit 26 may directly control various components of the present invention. For example, in one embodiment, the imaging device 7 is capable of turning and the user may control the angle and orientation of the imaging device 7 through the external control unit 26. In the preferred embodiment of the present invention, the external control unit 26 is integrated into the control console of the mobile crane.

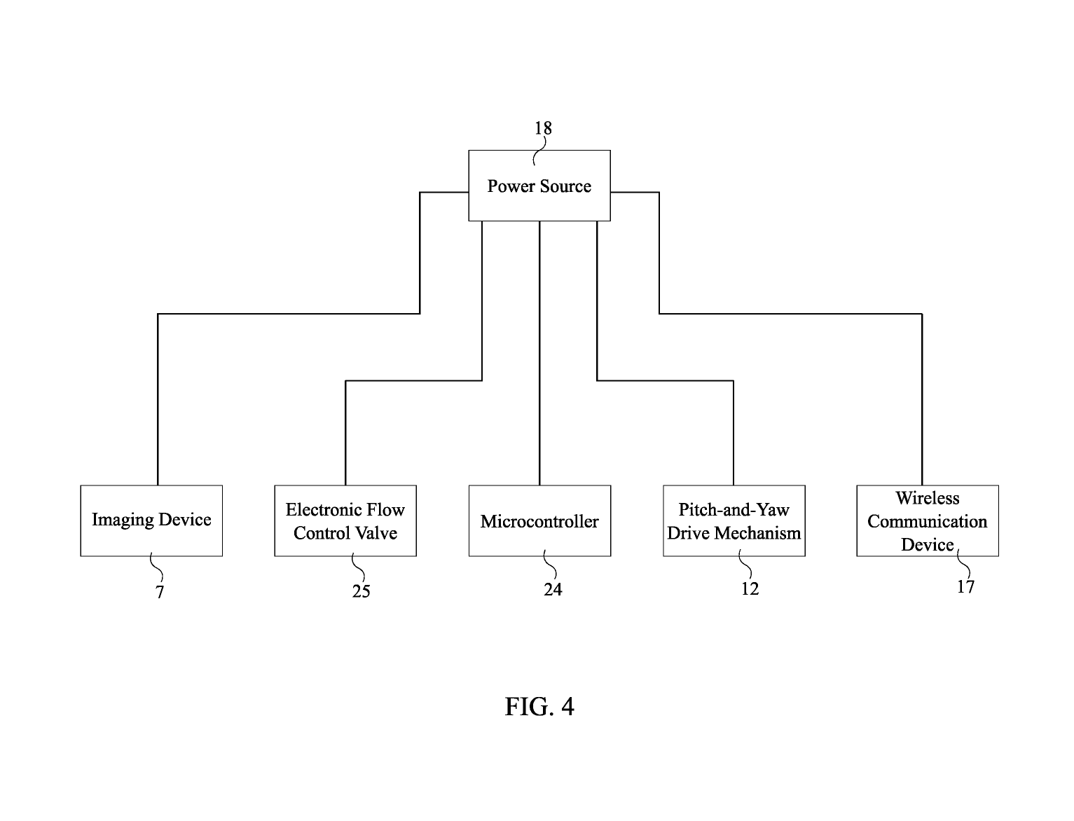

Referring to FIG. 4, the power source 18 supplies the electric energy for the electric components of the present invention. In particular, the power source 18 is electrically connected to the wireless communication device 17 and the imaging device 7. The power source 18 component may be implement in a multitude of means. In one embodiment of the present invention, the power source 18 is an internal battery pack that is housed within the mounting housing 1. In another embodiment of the present invention, the power source 18 is an external power source of the mobile crane. In this embodiment, the present invention receives electrical energy from the mobile crane. In another embodiment, the power source 18 comprises both the internal battery pack and the external power source as a redundancy measure.

Referring to FIG. 2, the present invention also comprises a lip 23 in order to shield and protect the imaging device 7 from the chemicals and liquids being expelled by the sprinkler gun 10. The lip 23 ensures that no debris, chemicals, or liquids come into contact with the imaging device 7 in order to ensure that a clear and unobstructed image is captured. The lip 23 is an elongated plate composed of the same material as the mounting housing 1. The lip 23 is perpendicularly connected to the front surface 3 of the mounting housing 1 and is positioned adjacent to the top surface 2 of the mounting housing 1. The imaging device 7 is positioned directly underneath the lip 23 for protection. More specifically, the imaging device 7 is positioned adjacent to the lip 23, opposite the sprinkler gun 10.

In the preferred embodiment of the present invention, the at least one imaging device 7 comprises an infrared camera 8 and an all-weather camera 9. The infrared camera 8 forms an image based on infrared radiation. As described above, the infrared camera 8 is positioned adjacent to the lip 23, opposite the sprinkler gun 10. Additionally, the infrared camera 8 is pivotably connected to the front surface 3 of the mounting housing 1. The infrared image allows the user to see through smoke in order to identify possible trapped people. Additionally, the infrared image conveys the relative temperatures of the surrounding environment and landscape to the user. This is ideal for identifying possible hotspots and allowing the user to position and redirect the boom 20 and the sprinkler gun 10 in a more effective region. The all-weather camera 9 provides a direct video feed of the environment directly in front of the mounting housing 1 to the user. Similar to the infrared camera 8, the all-weather camera 9 is positioned adjacent to the lip 23, opposite the sprinkler gun 10. The all-weather camera 9 is pivotably connected to the front surface 3 of the mounting housing 1. This allows the user to adjust the angle and orientation of the all-weather camera 9 to suit the circumstances of each specific situation. In one embodiment of the present invention, the infrared camera 8 and the all-weather camera 9 are each pivotably connected to the front surface 3 by an electronic pivot arm, thus allowing the user to remotely control the positioning of each component through the external control unit 26.

In the preferred embodiment of the present invention, the mounting housing 1 is designed to complement the distal end-plate 21 of the boom 20 and the fastening mechanism 5 that comprises a plurality of bolt-and-nut fasteners 6. The main purpose of the present invention is to provide a firefighting apparatus that can be easily and quickly deployed into the field. By complying with traditional designs of mobile cranes 19, any mobile crane may be retrofitted with the present invention with minor structural changes to the boom 20. The plurality of bolt-and-nut fasteners 6 allows for easy installation of the present invention while also ensuring that the connection between the boom 20 and the mounting housing 1 can withstand the forces and stresses associated with dispersing high volumes of liquid at relatively high velocity. In particular, each of the plurality of bolt-and-nut fasteners 6 includes an industrial sized bolt and a complimentary nut that are designed to withstand high forces and stresses. The plurality of bolt-and-nut fasteners 6 is perimetrically distributed around the bottom surface 4 of the mounting housing 1 in order to securely attach the mounting housing 1 to the distal end-plate 21 of the boom 20. In another embodiment of the present invention, the fastening mechanism 5 is a welding joint.

Referring to FIG. 1, in the preferred embodiment of the present invention, the sprinkler gun 10 is configured to continuously turn about a main axis. For this feature, the sprinkler gun 10 comprises a nozzle 11 and a reaction drive mechanism 13. The nozzle 11 is in fluid communication with the water-receiving tube 14 and controls the direction and the characteristics of the liquid flow from the sprinkler gun 10. The reaction drive mechanism 13 is mechanically integrated into the nozzle 11 in order to turn the nozzle 11 in incremental steps relative to the mounting housing 1 in order to address a wider area. A variety of mechanisms may be used for the reaction drive mechanism 13. In general, the reaction drive mechanism 13 engages the liquid stream from the nozzle 11 in order to apply a rotational force onto the nozzle 11 itself; this process is repeated in a cyclical fashion, rotating the nozzle 11 an incremental amount each time. In one embodiment, the reaction drive mechanism 13 comprises a reaction arm, a wedge, and a reverse mechanism. The reaction arm is pivotably mounted to the nozzle 11 with a distal end of the reaction arm extending directly in front of the nozzle 11. The wedge is pivotably attached to the distal end of the reaction arm and is oriented toward the nozzle 11 in order to engage the liquid stream from the nozzle 11. The reverse mechanism is mechanically integrated into the nozzle 11 and operatively coupled to the reaction arm. When the nozzle 11 discharges the liquid stream, the wedge engages the stream momentarily which produces an angled force onto the reaction arm. A vertical component of the angled force bounces the reaction arm downwards, thus pivoting about the nozzle 11. A horizontal component of the angled force transmits through the reaction arm and applies a lateral torque onto the nozzle 11, thus rotating the nozzle 11 an incremental amount. The reaction arm is then reversed back towards the liquid stream by a stop and the aforementioned process repeats. When the nozzle 11 rotates to a predetermined angle on either side of its body, the reverse mechanism shifts the reaction arm. This action laterally translates the wedge marginally such that when the liquid stream engages the wedge again, the horizontal component of the angled force is reversed. As a result, the nozzle 11 incrementally rotates back and forth along an arc, wherein the arc is pre-set by the reverse mechanism.

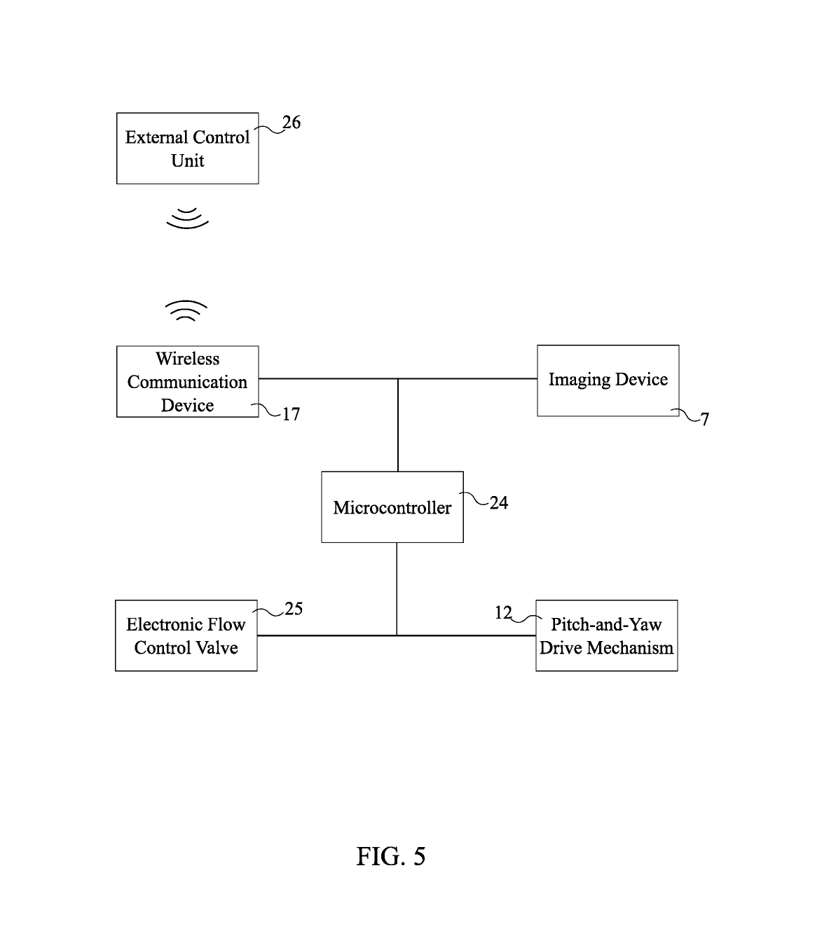

In one embodiment, the present invention further allows the user to remotely control the sprinkler gun 10. This is accomplished through the use of a microcontroller 24 and an electronic flow control valve 25. The electronic flow control valve 25 is mechanically integrated into the water-receiving tube 14 and regulates the flow of fire extinguishing substance through the water-receiving tube 14. Referring to FIG. 5, the microcontroller 24 instructs and manages the electronic components of the present invention. More specifically, the microcontroller 24 is internally mounted within the mounting housing 1 and is electronically connected to the imaging device 7, the wireless communication device 17, and the electronic flow control valve 25. Through the microcontroller 24, the electronic flow control valve 25, and the external control unit 26, the user may regulate the flow of fire extinguishing substance to the sprinkler gun 10 and resultantly control the area being addressed by the sprinkler gun 10. The power source 18 is electrically connected to the microcontroller 24 and the electric flow control valve 25 in order to provide electrical energy to the aforementioned components.

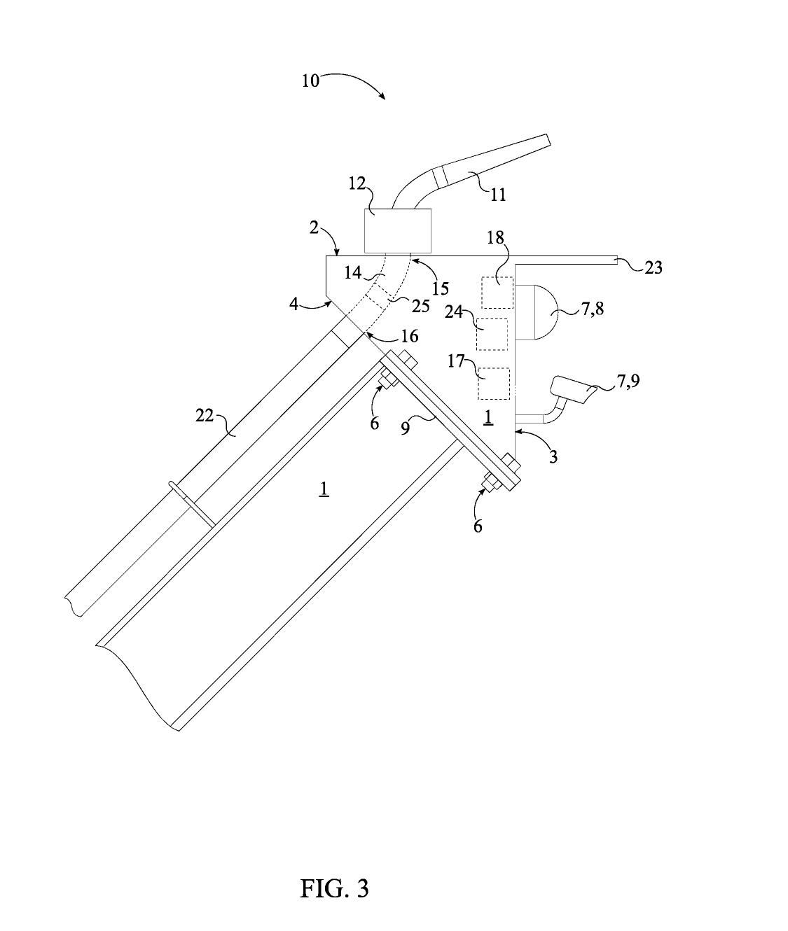

Referring to FIG. 3, in another embodiment, the present invention allows the user to directly and precisely position the sprinkler gun 10. In this embodiment, the sprinkler gun 10 comprises the nozzle 11 and a pitch-and-yaw drive mechanism 12. The pitch-and-yaw drive mechanism 12 allows for the complete control of the positioning of the nozzle 11 through the microcontroller 24 and the external control unit 26. In particular, the pitch-and-yaw drive mechanism 12 is mechanically integrated into the nozzle 11 in order to allow the user to remotely tilt and rotate the nozzle 11. Additionally, the pitch-and-yaw drive mechanism 12 is electronically connected to the microcontroller 24 and electrically connected to the power source 18. A variety of devices and technologies may be used for the pitch-and-yaw drive mechanism 12. In its simplest version, the pitch-and-yaw drive mechanism 12 comprises a multitude of motorized pivot junctions that are integrated in between the nozzle 11 and the mounting housing 1. Through the external control unit 26, the user may control the pitch and yaw of the nozzle 11, thus allowing him or her to address any specific area around the nozzle 11.

Although the invention has been explained in relation to its preferred embodiment, it is to be understood that many other possible modifications and variations can be made without departing from the spirit and scope of the invention as hereinafter claimed.

What is claimed is:

1. A rapid deployment boom-mounted sprinkler gun with distance and heat sensing capabilities comprises:
a mounting housing;
a fastening mechanism;
an at least one imaging device;
a sprinkler gun;
a water-receiving tube;
a wireless communication device;
a power source;
the sprinkler gun being rotatably mounted onto a top surface of the mounting housing;
a first end of the water-receiving tube being in fluid communication with the sprinkler gun;
a second end of the water-receiving tube being mechanically integrated into a bottom surface of the mounting housing;
the imaging device being externally mounted to a front surface of the mounting housing;
the wireless communication device being internally mounted within the mounting housing;
the power source being electrically connected to the imaging device and the wireless communication device;
the wireless communication device being electronically connected to the imaging device; and
the fastening mechanism being mechanically integrated into a bottom surface of the mounting housing.

2. The rapid deployment boom-mounted sprinkler gun with distance and heat sensing capabilities as claimed in claim 1 comprises:
the fastening mechanism comprises a plurality of bolt-and-nut fasteners; and
the plurality of bolt-and-nut fasteners being perimetrically distributed around the bottom surface of the mounting housing.

3. The rapid deployment boom-mounted sprinkler gun with distance and heat sensing capabilities as claimed in claim 2 comprises:
a boom;
the mounting housing being adjacently positioned with a distal end-plate of the boom; and
the mounting housing being attached to the distal end-plate of the boom by the plurality of bolt-and-nut fasteners.

4. The rapid deployment boom-mounted sprinkler gun with distance and heat sensing capabilities as claimed in claim 1 comprises:
a lip;
the at least one imaging device comprises an infrared camera;
the lip being perpendicularly connected to the front surface of the mounting housing;
the lip being positioned adjacent to the top surface of the mounting housing;
the infrared camera being positioned adjacent to the lip, opposite the sprinkler gun; and
the infrared camera being pivotably connected to the front surface of the mounting housing.

5. The rapid deployment boom-mounted sprinkler gun with distance and heat sensing capabilities as claimed in claim 1 comprises:
a lip;
the at least one imaging device comprises an all-weather camera;
the lip being perpendicularly connected to the front surface of the mounting housing;
the lip being positioned adjacent to the top surface of the mounting housing;
the all-weather camera being positioned adjacent to the lip, opposite the sprinkler gun; and
the all-weather camera being pivotably connected to the front surface of the mounting housing.

6. The rapid deployment boom-mounted sprinkler gun with distance and heat sensing capabilities as claimed in claim 1 comprises:
a water supply line;
the water supply line being adjacently connected to the second end of the water-receiving tube; and
the water supply line of the mobile crane being in fluid communication with the water-receiving tube.

7. The rapid deployment boom-mounted sprinkler gun with distance and heat sensing capabilities as claimed in claim 1 comprises:
a microcontroller;
an electronic flow control valve;
the microcontroller being internally mounted within the mounting housing;
the microcontroller being electronically connected to the imaging device, the wireless communication device, and the electronic flow control valve;
the electronic flow control valve being mechanically integrated into the water-receiving tube; and
the power source being electrically connected to the microcontroller and the electronic flow control valve.

8. The rapid deployment boom-mounted sprinkler gun with distance and heat sensing capabilities as claimed in claim 1 comprises:
a microcontroller;
the sprinkler gun comprises a nozzle and a pitch-and-yaw drive mechanism;
the microcontroller being internally mounted within the mounting housing;
the microcontroller being electronically connected to the imaging device, the pitch-and-yaw drive mechanism, and the wireless communication device;
the power source being electrically connected to the microcontroller and the pitch-and-yaw drive mechanism; and
the pitch-and-yaw driving mechanism being mechanically integrated into the nozzle.

9. The rapid deployment boom-mounted sprinkler gun with distance and heat sensing capabilities as claimed in claim 1 comprises:
an external control unit; and
the external control unit being communicably couple to the imaging device through the wireless communication device.

10. The rapid deployment boom-mounted sprinkler gun with distance and heat sensing capabilities as claimed in claim 1, wherein the power source is an internal battery pack.

11. The rapid deployment boom-mounted sprinkler gun with distance and heat sensing capabilities as claimed in claim 1, wherein the power source is an external power source.

12. The rapid deployment boom-mounted sprinkler gun with distance and heat sensing capabilities as claimed in claim 1 comprises:
the sprinkler gun comprises a nozzle and a reaction drive mechanism; and
the reaction drive mechanism being mechanically integrated into the nozzle.
